(19) United States
(12) Patent Application Publication
(10) Pub. No.: US 2018/0041900 A1
(43) Pub. Date: Feb. 8, 2018

(54) ANTI-THEFT SMART DEVICE SYSTEM

(71) Applicant: REGINA D. ANDERSON, JACKSON, MS (US)

(72) Inventor: REGINA D. ANDERSON, JACKSON, MS (US)

(21) Appl. No.: 15/225,840

(22) Filed: Aug. 2, 2016

(51) Int. Cl. H04W 12/08; H04L 29/06; H04W 12/06

(52) U.S. Cl. CPC H04W 12/08; H04W 12/06; H04L 63/102; H04L 63/083

(57) ABSTRACT

The present invention relates to an anti-theft smart device system enabled providing an extra layer of security against the theft of the article of manufacture. The anti-theft smart device system once installed in the article of manufacture enables the user to input a pass code before the article of manufacture is turned off. User executes function to power down the phone, enter the pass code into the input unit of the article of manufacture and once the pass code is entered correctly the user is allowed to select the turn off feature of the article of manufacture.

### FIELD OF THE INVENTION

The present invention relates to an anti-theft smart device system enabled providing an extra layer of security against the theft of the article of manufacture.

### BACKGROUND OF THE INVENTION

Every year 3.1 million phones are stolen. Today when a smart phone is lost or stolen the first thing a thief does is to turn the phone off, in order to prevent the owner of the phone from locating the phone remotely. When the phone is turned off the phone is no longer accessible remotely and its position cannot be located via GPS.

Currently, there exists software that allows a person to remotely locate their phone which is provided by the manufacturer. This software is enabled to provide the location of the phone the last time it was in the network. If the phone is powered off, the phone then is transported, converted, sold, or destroyed without the location being reported to this software.

Now, these days smart phones are also provided with several options to retain the phone out of the network that is either to switch off the phone, to switch on the airplane mode or to switch on the offline mode wherein, these mode enables the phone without a network and if any second user tries contacting to that phone then he/she will get an intimation that the phone is either switched off or is out of coverage area wherein one is not enabled to locate his/her phone location. These applications are enabled to identify the phones location only when the phone is kept in the network or is in use for a duration of time.

Therefore, there remains a need to overcome above mentioned problems and our invention resolves this entire problem.

### SUMMARY OF THE INVENTION

The main objective of the present invention is to overcome the limitations of the prior arts by providing a computationally implemented method enabled providing an extra layer of security against theft.

The present invention relates to an anti-theft smart device system. The user willing, a double security system for his/her article of manufacture is enabled to install the anti-theft smart device system on his/her article of manufacture wherein, the installation for the given anti-theft smart device system is done via various application stores available like ITunes or Google play but the scope of the invention is not limited to only this. Once the anti-theft smart device system is installed on the article of manufacture the at least one user is directed to the input unit wherein, the input unit is enabled to receive at least a first pass code input and at least a second pass code input. Herein, at least first code input is provided via owner of the article of the manufacture to keep the article of manufacture safe and this at least first pass code input is saved via input unit in the storage, wherein the storage is either internal memory storage or the online cloud storage. In case the article of manufacture with anti-theft smart device system is stolen by any thief and the thief is forcefully trying to do at least one of to turn off power of the article of manufacture, to convert an online mode of the article of manufacture into an offline mode and to turn off a telecommunication network of the article of manufacture, then anti-theft smart device system verifies at least second pass code input and at least first pass code input given by at least one user. This verification is done by comparison between at least first pass code input and at least second pass code input via a processor. The successful verification enables the anti-theft smart device system to perform at least one of turn off power to the article of manufacture, to convert an online mode of the article of manufacture into an offline mode and to turn off a telecommunication network of the article of manufacture and wherein, an unsuccessful verification enables the anti-theft smart device system to not perform at least one of to turn off power of the article of manufacture, to convert an online mode of the article of manufacture into an offline mode and to turn off a telecommunication network of the article of manufacture.

Also, in the present invention of an anti-theft smart device system, the at least one user if trying at least one of the following; to turn off power of the article of manufacture, to convert an online mode of the article of manufacture into an offline mode and to turn off a telecommunication network of the article of manufacture, is directed to a input unit wherein, the input unit is enabled to receive at least one pass code input via at least one user. The at least one pass code which is stored in either the internal memory storage or the online cloud memory, is further compared with at least a second pass code input entered by the at least one user to perform the various activities relating to the article of manufacture. The successful verification enables the anti-theft smart device system to perform at least one of the following; turn off power of the article of manufacture, to convert an online mode of the article of manufacture into an offline mode and to turn off a telecommunication network of the article of manufacture and wherein, an unsuccessful verification enables the anti-theft smart device system to not perform at least one of turn off power of the article of manufacture, to convert an online mode of the article of manufacture into an offline mode and to turn off a telecommunication network of the article of manufacture also, in such situation a GPS information of the at least one user article of manufacture is been sent to the at least second user's article of manufacture, wherein the article of manufacture of the at least second user herein, is considered as an alternative source of communication of the various information relating to the at least one user article of manufacture. This GPS information of the at least one user sent to the at least second user article of manufacture helps the at least one user to locate the article of manufacture for its correct location and enable providing security to the article of manufacture.

### BRIEF DESCRIPTION OF THE DRAWINGS

The following drawings illustrates exemplary embodiment; however, they are helpful in illustrating objects, features and advantages of the present invention because the present invention will be more apparent from the following detailed description taken in conjunction with accompanying drawings in which:

FIG. 1 illustrates the flow chart of the given invention which is also the preferred embodiment of the given invention according to an embodiment of the invention.

### DETAIL DESCRIPTION OF THE INVENTION

Reference will now be made in detail to the exemplary embodiment(s) of the invention, examples of which are illustrated in the accompanying drawings. Whenever possible, the same reference numerals will be used throughout the drawings to refer to the same or like parts.

References to “one embodiment,” “at least one embodiment,” “an embodiment,” “one example,” “an example,” “for example,” and so on indicate that the embodiment(s) or example(s) may include a particular feature, structure, characteristic, property, element, or limitation but that not every embodiment or example necessarily includes that particular feature, structure, characteristic, property, element, or limitation. Further, repeated use of the phrase “in an embodiment” does not necessarily refer to the same embodiment.

Unless defined otherwise, all technical and scientific terms used herein have the same meaning as commonly understood by one of ordinary skill in the art to which this invention belongs. Although any methods and materials similar or equivalent to those described herein can also be used in the practice or testing of the present invention, the preferred methods and materials are now described. All publications, patents and patent computer implemented methods mentioned herein are incorporated herein in their entirety.

The present invention relates to an anti-theft smart device system enabled providing an extra layer of security against the theft. The anti-theft smart device system once installed would require the at least one user to input a code before the article of manufacture could be powered down. The at least one user executes a function to power down the article of manufacture, a code input unit is presented; once the code is entered correctly the at least one user is allowed to select the turn off feature for the at least one user article of manufacture.

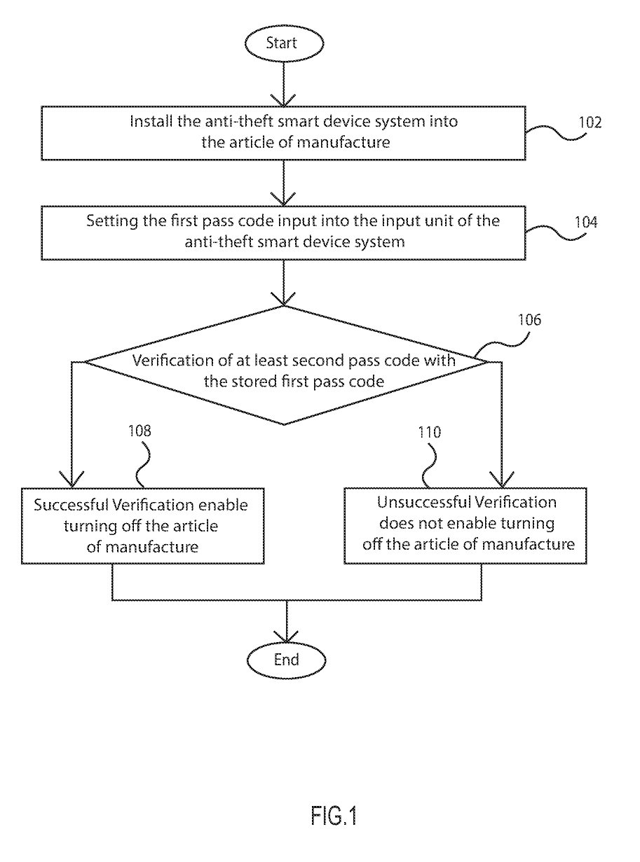

FIG. 1 illustrates the flow chart [100] of the given invention of the anti-theft smart device system which is also the preferred embodiment of the given invention.

Step.102 of FIG. 1 illustrates the process of installation of the anti-theft smart device system into the article of manufacture wherein, the installation of the anti-theft smart device system takes place via various stores available, for example Google play store and iTunes which is the most popular application stores in the primary market and for the android version of the anti-theft smart device system, there are several new stores present all over the cyber world such as Apply, Samsung Apps, F-droid, Slide ME, Get Jar and Amazon. After the at least one user installs the anti-theft smart device system on his/her article of manufacture the user gets started for the further process for which the anti-theft smart device system is been designed.

Step.104 of FIG. 1 illustrates the process of setting at least first pass code input via at least one user into the input unit of the anti-theft smart device system. In the given invention of an anti-theft smart device system, when the at least one user installs the anti-theft smart device system on his/her article of manufacture then he/she is directed to an input unit, wherein this input unit is enabled to receive at least a first pass code input and at a least second pass code input. Among the two pass code inputs the input unit is enabled to save at least the first pass code input in its storage, wherein the storage is either internal memory storage or online cloud storage. The user for the entry of at least a first pass code input is either the owner of the article of manufacture or any person who is been granted the permission to access the article of manufacture. The input unit is further enabled to receive at least a second pass code input, wherein at least a second pass code input is given by either the owner of the article of manufacture or by any second user. Moreover, at least a first and at least a second pass code input given to the input unit is either a numeric pass code, an alpha numeric pass code, a alphabetical pass code, a biometric input or the combination of thereof.

Step.106 of FIG. 1 illustrates verification of at least a second pass code from at least a first pass code. In a situation of use, if at least one user who is trying at least one of the following; to turn off power of the article of manufacture, to convert an online mode of the article of manufacture into an offline mode and to turn off a telecommunication network of the article of manufacture by giving at least a second pass code input, then the processor enables verification of at least a second pass code input via at least first pass code input by comparing at least a first pass code input to at least a second pass code input. During the comparison the at least second pass code input either matches the at least first pass code or does not match the at least first pass code. Therefore, step 108 illustrates the successful verification enabling the anti-theft smart device system to perform at least one of the following; to turn off power of the article of manufacture, to convert an online mode of the article of manufacture into an offline mode and to turn off a telecommunication network of the article of manufacture. Step.110 illustrates an unsuccessful verification of at least second pass code in comparison to at least a first pass code and enables the anti-theft smart device system to not perform at least one of the following; to turn off power of the article of manufacture, to convert an online mode of the article of manufacture into an offline mode and to turn off a telecommunication network of the article of manufacture. Herein, if at least a second pass code input does not match at least a first pass code input for more than two or three attempts then the anti-theft smart device system gets an impression that at least one user is forcefully trying to do at least one of to turn off power of the article of manufacture, to convert an online mode of the article of manufacture into an offline mode and to turn off a telecommunication network of the article of manufacture, then in such situation a GPS information of the at least one user article of manufacture is been sent to the at least second user's article of manufacture, wherein the article of manufacture for the at least second user herein, is considered as an alternative source of communication of the various information relating to the at least one user article of manufacture. This GPS information of the at least one user article of manufacture is sent to the at least second user article of manufacture which helps the at least one user to locate the article of manufacture for its correct location and enable providing security to the article of manufacture.

In the preferred embodiment of the given invention the user willing a double security system for his/her article of manufacture is enabled to install the anti-theft smart device system on his/her article of manufacture wherein the installation for the given anti-theft smart device system is done via various application stores available like iTunes or Google play but the scope of the invention is not limited to only this. Once the anti-theft smart device system is installed on the article of manufacture at least one user is directed to the input unit wherein the input unit is enabled to receive at least a first pass code input and at least a second pass code input. Herein, at least a first code input is provided via the owner of the article of manufacture to keep the article of manufacture safe and the at least first pass code input is saved via input unit in the storage wherein the storage is either internal memory or the online cloud in which at least a first pass code input is saved. In the case when the article of manufacture with anti-theft security smart device system is stolen by any thief and the thief is forcefully trying to do at least one of the following; turn off power of the article of manufacture, to convert an online mode of the article of manufacture into an offline mode and to turn off a telecommunication network of the article of manufacture, then the anti-theft smart device system verifies at least a second pass code input and at least a first pass code input given by at least one user. This verification is done by comparison between at least a first pass code input and at least a second pass code input. The successful verification of the at least a second pass code from at least a first pass code enables the anti-theft smart device system to perform at least one of the following; turn off power of the article of manufacture, to convert an online mode of the article of manufacture into an offline mode and to turn off a telecommunication network of the article of manufacture. The unsuccessful verification of the at least a second pass code from at least a first pass code enables the anti-theft smart device system to not perform at least one of turn off power of the article of manufacture, to convert an online mode of the article of manufacture into an offline mode and to turn off a telecommunication network of the article of manufacture. Also, in such situation a GPS information of the at least one user article of manufacture is been sent to the at least second user's article of manufacture, wherein the article of manufacture of the at least second user herein, is considered as an alternative source of communication of the various information relating to the at least one user article of manufacture. This GPS information of the at least one user sent to the at least second user article of manufacture helps the at least one user to locate the article of manufacture for its correct location and enable providing security to the article of manufacture.

In another embodiment of the given invention, if at least one user is trying to either turn off the article of manufacture, to convert an online mode of the article of manufacture into an offline mode or to turn off a network of the article of manufacture, the user is directed to a input unit wherein at least one user input with at least a first pass code input which is also stored in the internal memory or online cloud of the article of manufacture and then the user is enabled to access the various functionality of the article of manufacture.

While the invention has been described in detail with specific reference to preferred embodiments thereof, it is understood that variations and modifications thereof may be made without departing from the true spirit and scope of the invention.

What is claimed is:

1. A computationally implemented method on an article of manufacture, wherein the computationally implemented method restricts a user to perform at least one of turn off power of the article of manufacture, to convert an online mode of the article of manufacture into an offline mode and to turn off a telecommunication network of the article of manufacture, wherein the computationally implemented method comprises:
a) an input unit, wherein the input unit is configured to receive at least one second pass code input for the article of manufacture: and
b) a processor, operationally coupled to the input unit, wherein the processor enables verification of the received at least one second pass code by comparing it with a first pass code input, previously stored in the storage, wherein a successful verification enables the computationally implemented method to perform at least one of turn off power of the article of manufacture, to convert an online mode of the article of manufacture into an offline mode and to turn off a telecommunication network of the article of manufacture.

2. The computationally implemented method in claim 1; wherein an unsuccessful verification of the at least second pass code from at least first pass code enables the computationally implemented method to not perform at least one of turn off power of the article of manufacture, to convert an online mode of the article of manufacture into an offline mode and to turn off a telecommunication network of the article of manufacture.

3. The computationally implemented method in claim 1; wherein at least first pass code input and at least second pass code input is at least a numeric input, an alphabetical input, an alpha numeric input, or a biometric input.

4. The computationally implemented method in claim 1; wherein the storage is at least one of the internal memory storage or the online cloud storage. cm 5. The computationally implemented method in claim 1; wherein the successful verification of the at least second pass code from at least first pass code enables the computationally implemented method to enable at least one user to access a memory of the article of manufacture.

6. The computationally implemented method in claim 1; wherein an online mode of the article of manufacture includes at least one of internet connectivity, network availability and voice mode accessibility.

7. A computationally implemented method on an article of manufacture, wherein the computationally implemented method restricts a user to perform at least one of turn off power of the article of manufacture, to convert an online mode of the article of manufacture into an offline mode and to turn off a telecommunication network of the article of manufacture, wherein the computationally implemented method comprises:
a) an input unit, wherein the input unit is configured to receive at least one second pass code input for the article of manufacture; and
b) a processor, operationally coupled to the input unit, wherein the processor enables verification of the received at least one second pass code by comparing it with a first pass code input, previously stored in the storage, wherein a successful verification enables the computationally implemented method to perform at least one of turn off power of the article of manufacture, to access an internal memory, to convert an online mode of the article of manufacture into an offline mode and to turn off a telecommunication network of the article of manufacture.

8. The computationally implemented method in claim 7; wherein an unsuccessful verification of the at least second pass code from at lease first pass code enables the computationally implemented method to not perform at least one of turn off power of the article of manufacture, to access the internal memory, to convert an online mode of the article of manufacture into an offline mode and to turn off a telecommunication network of the article of manufacture.

9. The computationally implemented method in claim 7; wherein at least first pass code input and at least second pass code input is at least a numeric input, an alphabetical input, an alpha numeric input, or a biometric input.

10. The computationally implemented method in claim 7; wherein the storage is at least internal memory storage or online cloud storage.

11. The computationally implemented method in claim 7; wherein an online mode of the article of manufacture includes at least one of internet connectivity, network availability and voice mode accessibility.

12. The computationally implemented method in claim 7; wherein the computationally implemented method is enabled to show a mock input unit as the input unit in the article of manufacture wherein the mock input unit is not capable of receiving at least first pass code input or at least second pass code input, if at least one user is forcefully trying to either turn off the article of manufacture, to convert an online mode of the article of manufacture into an offline mode or to turn off a network of the article of manufacture.
